(19) United States
(12) Patent Application Publication
(10) Pub. No.: US 2023/0368067 A1
(43) Pub. Date: Nov. 16, 2023

(54) PERFORMANCE PREDICTION USING MACHINE LEARNING

(71) Applicant: SAP SE, Walldorf (DE)

(72) Inventors: Swantje Lange, Darmstadt (DE); Britta Jung, Zeiskam (DE)

(21) Appl. No.: 17/741,129

(22) Filed: May 10, 2022

(51) Int. Cl. G06N 20/00; G06N 7/00

(52) U.S. Cl. CPC G06N 20/00; G06N 7/005

(57) ABSTRACT

Techniques for predicting performance of an entity using machine learning are disclosed. In some embodiments, a computer system performs a method comprising: for each category of performance in a plurality of categories of performance: accessing reference data from data sources corresponding to the category, each reference data comprising reference data points for each reference entity in a plurality of reference entities; deriving training data using a k-means clustering algorithm and the reference data corresponding to the category; training a corresponding naïve Bayes classifier using the training data corresponding to the category; accessing target data from the data sources corresponding to the category, each target data comprising target data points for a target entity; and computing a classification label for the category based on the target data corresponding to the category using the naïve Bayes classifier corresponding to the category.

### BACKGROUND

Prediction systems may extract information from data to compute an inference about the data.

### BRIEF DESCRIPTION OF THE DRAWINGS

Some example embodiments of the present disclosure are illustrated by way of example and not limitation in the figures of the accompanying drawings, in which like reference numbers indicate similar elements.

FIG. 1 is an example network diagram illustrating a system.

FIG. 2 is a block diagram illustrating an example performance prediction system.

FIG. 3 illustrates an example graphical user interface (GUI) via which one or more classification labels are displayed.

FIG. 4 is a flowchart illustrating an example method of predicting performance of an entity using machine learning.

FIG. 5 is a flowchart illustrating another example method of predicting performance of an entity using machine learning.

FIG. 6 is a block diagram of an example computer system on which methodologies described herein can be executed.

### DETAILED DESCRIPTION

Example methods and systems for predicting performance of an entity using machine learning are disclosed. In the following description, for purposes of explanation, numerous specific details are set forth in order to provide a thorough understanding of example embodiments. It will be evident, however, to one skilled in the art that the present embodiments can be practiced without these specific details.

Current prediction systems fail to accurately and efficiently predict the performance of an entity. The amount of data available for predicting performance is extremely large, thereby making the processing of such data computationally expensive. Furthermore, the large amount of data includes a significant amount of noisy data. As a result, these technical problems make it difficult for current prediction systems to accurately and efficiently predict the performance of an entity. In addition to the issues discussed above, other technical problems may arise as well.

The implementation of the features disclosed herein involves a non-generic, unconventional, and non-routine operation or combination of operations. By applying one or more of the solutions disclosed herein, some technical effects of the system and method of the present disclosure are to provide a prediction system that accurately and efficiently predicts the performance of an entity. In some example embodiments, a computer system, for each category of performance in a plurality of categories of performance, accesses a corresponding set of reference data from a set of data sources corresponding to the category of performance, uses a k-means clustering algorithm to derive a corresponding set of training data for each category of performance in a plurality of categories of performance using the set of reference data corresponding to the category of performance, and then, for each category of performance in the plurality of categories of performance, trains a corresponding naïve Bayes classifier using the set of training data that corresponds to the category of performance. The trained naïve Bayes classifiers may then be used to compute corresponding classification labels for the categories of performance for a target entity.

The term “reference” is used herein to indicate data and entities being used or involved in the training of components, such as in the training of the naïve Bayes classifiers. The term “target” is used herein to indicate data and entities being used or involved in the use of the trained components, such as in the use of the trained naïve Bayes classifiers.

By using the k-means clustering algorithm, the computer system can minimize the computational burden involved in processing large amounts of reference data, thereby making the training of the naïve Bayes classifiers more efficient. Additionally, by using different sets of reference data from different sets of data sources to specifically train different naïve Bayes classifiers for particular categories of performance, the computer system increases the accuracy of the output generated by the performance prediction system that uses the trained naïve Bayes classifiers. Furthermore, the computer system may use a natural language processing algorithm to compute a corresponding level of relevance for target data that is used in computing the corresponding classification label for one of the categories of performance for the target entity, and then use the corresponding level of relevance in computing the corresponding classification label for the category of performance, such as by omitting the target data from use in the computing of the corresponding classification label or by weighting the target data based on the corresponding level of relevance. As a result of using the natural language processing algorithm to compute the corresponding level of relevance and then using the corresponding level of relevance in the computing of the corresponding classification label, the computer system may efficiently process target data to determine its relevance to the particular category of performance for which it is to be potentially used in the computation of the corresponding classification label and configure its use in the computation based on the determined level of relevance, thereby increasing the accuracy of the performance prediction system. Other technical effects will be apparent from this disclosure as well.

The methods or embodiments disclosed herein may be implemented as a computer system having one or more modules (e.g., hardware modules or software modules). Such modules may be executed by one or more hardware processors of the computer system. In some example embodiments, a non-transitory machine-readable storage device can store a set of instructions that, when executed by at least one processor, causes the at least one processor to perform the operations and method steps discussed within the present disclosure.

The details of one or more variations of the subject matter described herein are set forth in the accompanying drawings and the description below. Other features and benefits of the subject matter described herein will be apparent from the description and drawings, and from the claims.

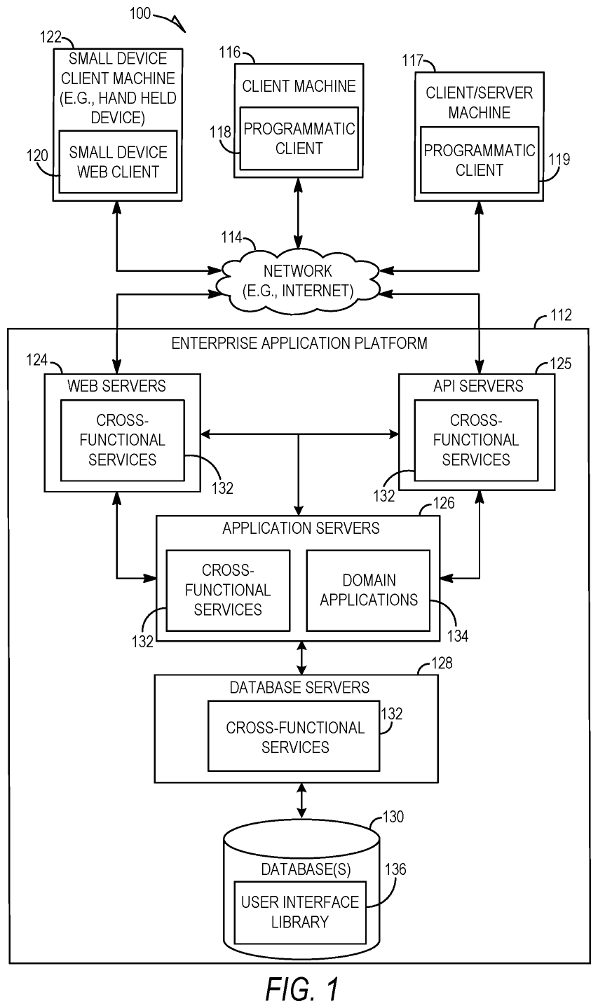

FIG. 1 is an example network diagram illustrating a system 100. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with a small device web client 120 (e.g., a browser without a script engine), and a client/server machine 117 with a programmatic client 119.

Turning specifically to the enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. The web servers 124, API servers 125, application servers 126, and database servers 128 can host cross-functional services 132. The cross-functional services 132 can include relational database modules to provide support services for access to the database(s) 130, which includes a user interface library 136. The application servers 126 can further host domain applications 134. The web servers 124 and the API servers 125 may be combined.

The cross-functional services 132 provide services to users and processes that utilize the enterprise application platform 112. For instance, the cross-functional services 132 can provide portal services (e.g., web services), database services, and connectivity to the domain applications 134 for users that operate the client machine 116, the client/server machine 117, and the small device client machine 122. In addition, the cross-functional services 132 can provide an environment for delivering enhancements to existing applications and for integrating third-party and legacy applications with existing cross-functional services 132 and domain applications 134. In some example embodiments, the system 100 comprises a client-server system that employs a client-server architecture, as shown in FIG. 1. However, the embodiments of the present disclosure are, of course, not limited to a client-server architecture, and could equally well find application in a distributed, or peer-to-peer, architecture system.

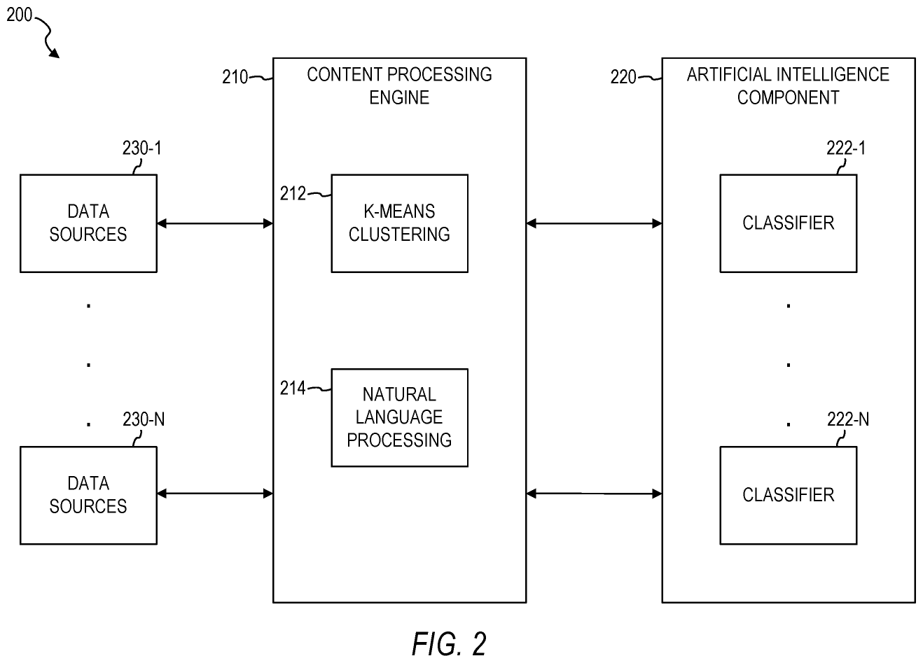

FIG. 2 is a block diagram illustrating an example performance prediction system 200. In some example embodiments, the performance prediction system 300 comprises a content processing engine 210 and an artificial intelligence component 220. The performance prediction system 300 may also comprise one or more data sources 230 (e.g., data source 230-1, . . . , data source 230-N). The content processing engine 210 and the artificial intelligence component 220, as well as one or more of the data sources 230, can reside on a computer system, or other machine, having a memory and at least one processor (not shown). In some embodiments, the content processing engine 210 and the artificial intelligence component 220 are incorporated into the application server(s) 126 in FIG. 1 and the data sources 230 are incorporated into the database(s) 130 in FIG. 1. However, it is contemplated that other configurations of the content processing engine 210, the artificial intelligence component 220, and the data sources 230 are also within the scope of the present disclosure. The content processing engine 210 and the artificial intelligence component 220 may be configured to perform various communication functions to facilitate the functionality described herein, such as by communicating with a computing device (e.g., the small device client machine 122, the client machine 116, or the client/server machine 117) via the network 114 using a wired or wireless connection.

In some example embodiments, one or more of the content processing engine 210 and the artificial intelligence component 220 are configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the content processing engine 210 and the artificial intelligence component 220 are configured to receive user input. For example, one or more of the content processing engine 210 and the artificial intelligence component 220 can present one or more graphical user interface (GUI) elements (e.g., drop-down menu, selectable buttons, text field) with which a user can submit input.

The performance prediction system 200 may be configured to predict the performance of an entity. The entity may comprise a person who is employed by an organization. For example, the performance prediction system 200 may be configured to predict the performance of the person with respect to their employment at the organization, such as to assess the performance of the person as a programmer at the organization.

In some example embodiments, the performance prediction system 200 is configured to predict the performance of the entity in each one of a plurality of categories of performance using a separate dedicated classifier 222 for each category of performance. For example, the artificial intelligence component 220 may train classifier 222-1 to compute a classification label for effort, classifier 222-2 to compute a classification label for discipline, classifier 222-3 to compute a classification label for teamwork, and so on and so forth for each category of performance in a plurality of categories of performance. In some example embodiments, each classifier 222 comprises a naïve Bayes classifier. Naïve Bayes classifiers are a family of probabilistic classifiers based on applying Bayes' theorem with strong independence assumptions between the features. They assign classification labels to problem instances, represented as vectors of feature values, where the classification labels are drawn from some finite set. Naïve Bayes classifiers assume that the value of a particular feature is independent of the value of any other feature, given the class variable. Since naïve Bayes classifiers only require a small amount of training data to estimate the parameters necessary for classification, the artificial intelligence component 220 may improve the efficiency of the performance prediction system 200 by using naïve Bayes classifiers, thereby enabling the performance prediction system 200 to accommodate a significantly larger number of categories of performance by making the training of a corresponding larger number of classifiers highly scalable. As a result of making the number of category-specific classifiers 222 highly scalable, the accuracy of the performance prediction system 200 is improved.

The performance prediction system 200 may use a different set of reference data to train each classifier 222, and each set of reference data may be obtained from a different set of data sources 230. For example, the artificial intelligence component 220 may use a first set of reference data from a first set of data sources 230-1 to train a first classifier 222-1, a second set of reference data from a second set of data sources 230-2 to train a second classifier 222-2, a third set of reference data from a third set of data sources 230-3 to train a third classifier 222-3, and so on and so forth.

In order to maximize the accuracy of the prediction results of the classifiers 222, the performance prediction system 200 may use a k-means clustering algorithm 212 to cluster the reference data into training data for use in training the classifiers 222. K-means clustering is a method of vector quantization that aims to partition n observations into k clusters in which each observation belongs to the cluster with the nearest mean (e.g., cluster centers or cluster centroid), serving as a prototype of the cluster. In some example embodiments, the content processing engine 210 is configured to, for each category of performance in a plurality of categories of performance, access a corresponding set of reference data from a set of data sources 230 corresponding to the category of performance. Each corresponding set of reference data may comprise a corresponding set of reference data points for each reference entity in a plurality of reference entities.

In one example, the plurality of reference entities comprises a plurality of people employed at an organization, and each person in the plurality of people has a corresponding set of reference data. Examples of the categories of performance may include, but are not limited to, effort, discipline, teamwork, support of colleagues, engagement, customer orientation, adaptability, and education. Each category of performance may have its own set of reference data that includes a corresponding set of reference data points. For example, the category of effort may have a corresponding set of reference data points that includes, but is not limited to, a number of backlog items of an employee in an issue tracking system (e.g., a computer software package that manages and maintains a list of issues, such as units of work to accomplish an improvement in a system), data of a burndown chart (e.g., a representation of work left to do versus time) of an employee, an amount of an employee's code stored in a version control system, a level of complexity of employee's code in a version control system, number or amount of rewards for contributions of employee for a specific project or task, a current career stage of an employee, and a speed of promotion to a next career stage for an employee. The category of discipline may have a corresponding set of reference data points that includes, but is not limited to, an amount of test coverage of an employee's code, a number of trainings (e.g., online courses) completed by an employee, and a number of software components for which an employee is responsible. The different reference data points may be stored in and obtained from corresponding data sources 230. For example, the reference data points that correspond to the category of effort may be stored in and obtained from a first set of one or more data sources 230-1, the reference data points that correspond to the category of discipline may be stored in and obtained from a second set of one or more data sources 230-2, and so on and so forth.

For each category of performance in the plurality of categories of performance, the content processing engine 210 may obtain a corresponding set of reference data from the data source 230 that corresponds to the category of performance, and then derive a corresponding set of training data using a k-means clustering algorithm and the set of reference data that corresponds to the category of performance. The artificial intelligence component 220 may then, for each category of performance in the plurality of categories of performance, train a corresponding classifier 222 using the set of training data corresponding to the category of performance. For example, the artificial intelligence component 220 may train a first classifier 222-1 using a first set of training data that corresponds to the category of effort, a second classifier 222-2 using a second set of training data that corresponds to the category of discipline, and so on and so forth.

In some example embodiments, the performance prediction system 200 is configured to use the trained classifiers 222 to predict a performance of a target entity. For example, the artificial intelligence component 220 may, for each category of performance in the plurality of categories of performance, access a corresponding set of target data from the set of data sources 230 corresponding to the category of performance. Each corresponding set of target data may comprise a set of target data points for the target entity, similar to each set of reference data comprising a set of reference data points for the reference entity, as previously discussed. The artificial intelligence component 220 may, for each category of performance in the plurality of categories of performance, compute a corresponding classification label for the category of performance based on the set of target data corresponding to the category of performance using the trained classifier 222 corresponding to the category of performance. For example, the artificial intelligence component 220 may compute a first classification label for the category of effort for a target entity using a first classifier 222-1, a second classification label for the category of discipline for the target entity using a second classifier 222-2, and so on and so forth for each category of performance in plurality of categories of performance.

The artificial intelligence component 220 may cause the corresponding classification labels for the plurality of categories of performance to be displayed on a computing device, such as on a computing device of a manager of an organization who has submitted a request to the artificial intelligence component 220 for a prediction of the performance of the target entity, where the target entity is an employee of the organization. Each computed classification label may be displayed on the computing device in association with an identification of the category of performance to which it corresponds.

In some example embodiments, the artificial intelligence component 220 computes a single classification label for the target entity based on the corresponding classification labels computed for the plurality of categories of performance. The corresponding classifier 222 may, for each category of performance in the plurality of categories of performance, compute a corresponding probability value for the classification label corresponding to the category. The artificial intelligence component 220 may compute a single classification label indicating an overall performance of the target entity based on the corresponding probability values computed by the corresponding classifiers 222 of the plurality of categories of performance, and then cause the single classification label to be displayed on a computing device. For example, the artificial intelligence component 220 may weight each classification label for the plurality of categories of performance based on the corresponding probability value with which the corresponding classifier 222 predicted the classification label, and then use an aggregation of the weighted classification labels to compute the single classification label that indicates the overall performance of the target entity.

The artificial intelligence component 220 may compute a forecast of the future evolution of a target entity's performance. For example, the artificial intelligence component 220 may compute a linear regression over the target data on different points in time to get a numerical performance value. These values can then be used to train a long short-term memory (LSTM) neural network to compute such forecasts.

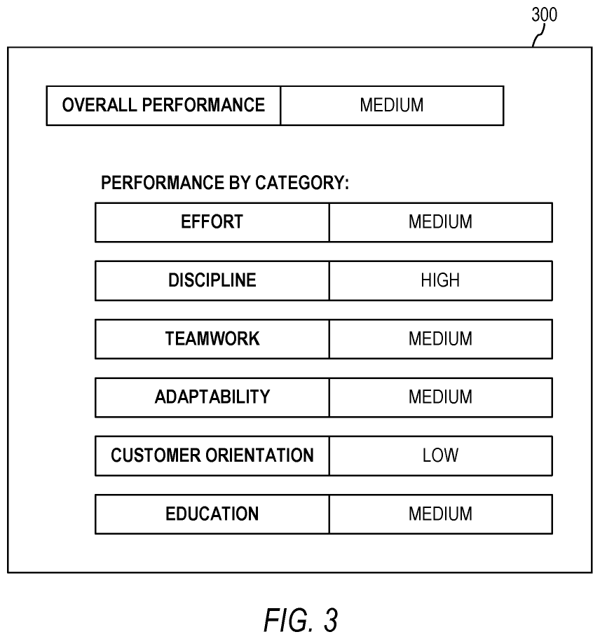

FIG. 3 illustrates an example graphical user interface (GUI) 300 via which one or more classification labels are displayed. For example, in FIG. 3, a manager of an organization may have submitted, a request for a performance prediction for an employee of the organization to the performance prediction system 200 via a computing device of the manager. In response to the request submitted by the manager via the computing device, the performance prediction system 200 may compute a corresponding classification label for a plurality of categories of performance for the employee, as well as a single classification value for the overall performance of the employee, and then display the classification values on the computing device of the manager, as shown in FIG. 3.

Additionally, in some example embodiments, the artificial intelligence component 220 notifies an entity when another entity has requested and been presented with performance prediction data. For example, when a manager of an organization submits a request to the performance prediction system 200 to predict the performance of an employee of the organization, and the artificial intelligence component 220 computes classification labels for categories of performance or a single classification label for the overall performance of the employee and displays the computed classification label(s) to the manager, the artificial intelligence component 220 may also transmit a notification to a computing device of the employee (or otherwise cause the notification to be displayed on a computing device of the employee). The notification may include an identification of the manager who requested the performance prediction data, a description of the classification labels computed and presented to the manager, and the target data or any other data of the employee that was used to compute the classification labels. Furthermore, employees may request a performance prediction of themselves and be presented with corresponding performance prediction data, thereby enabling employees to check and adapt their own performance.

The relevance of the data stored in the data sources 230 to the categories of performance for which they are being obtained may vary. For example, as previously discussed, one of the data sources 230 may store a record of the trainings that have been completed by an employee. Although the number of completed trainings may be used to compute a classification label for a category of performance for the employee, some of the completed trainings might be less relevant than other completed trainings or might simply be not relevant at all. For example, if the employee is a computer programmer, a completed training for using a particular version control system might be significantly more relevant than a completed training for marketing.

The performance prediction system 200 may determine a level of relevance for one or more of the target data points obtained from the data sources 230, and then base the computing of one or more of the classification labels at least in part on the level of relevance. However, computing levels of relevance for each possible combination of target data point and target entity would be place a significant processing burden on the underlying computer system, and storing the computed levels of relevance for all of the possible combinations would similarly consume an excessive amount of data storage. In order to solve these technical problems, the content processing engine 210 may use a natural language processing algorithm 214 to, for at least one category of performance in the plurality of categories of performance, compute a corresponding level of relevance of at least one target data point in the set of target data points to the target entity. The artificial intelligence component 220 may then compute of the corresponding classification label for the at least one category of performance in the plurality of categories of performance is based on the computed level of relevance.

In some example embodiments, the artificial intelligence component 220 may omit the at least one target data point from use in the computing of the corresponding classification label for the at least one category of performance based on the corresponding level of relevance for the at least one target data point and a threshold relevance value. For example, if the artificial intelligence component 220 determines that the corresponding level of relevance for the at least one target data point is below the threshold relevance value, then the artificial intelligence component 220 may omit the at least one target data point from use in the computing of the corresponding classification label in response to that determination.

Additionally or alternatively, the artificial intelligence component 220 may weight the at least one target data point in the computing of the corresponding classification label for the at least one category of performance based on the corresponding level of relevance for the at least one target data point. For example, the target data points may be weighted in proportion to their corresponding levels of relevance, such that the higher the relevance of a target data point, the higher the weight assigned to the target data point.

In some example embodiments, the content processing engine 210 may compute the level of relevance of a target data point by accessing corresponding text associated with the target data point, and then inputting the corresponding text into the natural language processing algorithm 214. For example, the content processing engine 210 may obtain a transcript of a completed training (e.g., an online course) from the data source 230, as well as metadata of the target entity (e.g., a job title, a job description), and then input the text of the transcript and the metadata of the target entity into the natural language processing algorithm 214. The natural language processing algorithm 214 may then compute a level of relevance based on a comparison of the inputted text of the transcript and the metadata of the target entity.

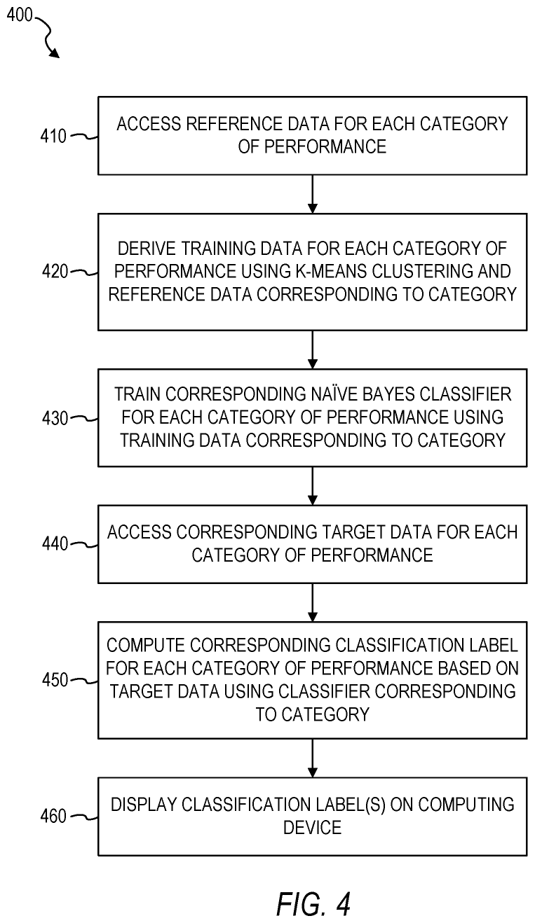

FIG. 4 is a flowchart illustrating an example method 400 of predicting performance of an entity using machine learning. The method 400 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 400 are performed by the performance prediction system 200 of FIG. 2 or any combination of one or more of its components (e.g., the content processing engine 210, the artificial intelligence component 220).

At operation 410, the performance prediction system 200 may, for each category of performance in a plurality of categories of performance, access a corresponding set of reference data from a set of data sources 230 corresponding to the category of performance. Each corresponding set of reference data may comprise a corresponding set of reference data points for each reference entity in a plurality of reference entities. Each reference data point in the set of reference data points may correspond to a different data source in the set of data sources 230.

Next, the performance prediction system 200 may, for each category of performance in the plurality of categories of performance, derive a corresponding set of training data using a k-means clustering algorithm 212 and the set of reference data corresponding to the category of performance, at operation 420. For example, the k-means clustering algorithm 212 may be used to cluster the reference data into different clusters of training data that correspond to different classification labels, such as a first cluster of training data that corresponds to a low performance level, a second cluster of training data that corresponds to a medium performance level, and a third cluster of training data that corresponds to a high performance level. Other configurations of clusters are also within the scope of the present disclosure.

The performance prediction system 200 may then, at operation 430, for each category of performance in the plurality of categories of performance, train a corresponding naïve Bayes classifier 222 using the set of training data corresponding to the category of performance. Other types of classifiers 222 other than naïve Bayes classifiers 222 may also be used.

At operation 440, the performance prediction system 200 may, for each category of performance in the plurality of categories of performance, access a corresponding set of target data from the set of data sources 230 corresponding to the category of performance. Each corresponding set of target data may comprise a set of target data points for a target entity. In some example embodiments, the target entity comprises a person employed by an organization, and the corresponding sets of data sources for each one of the plurality of categories of performance comprise one or more databases of the organization.

Next, for each category of performance in the plurality of categories of performance, the performance prediction system 200 may compute a corresponding classification label for the category of performance based on the set of target data corresponding to the category of performance using the trained naïve Bayes classifier 222 corresponding to the category of performance, at operation 450.

The performance prediction system 200 may then, at operation 460, cause the corresponding classification labels for the plurality of categories of performance to be displayed on a computing device, as discussed above with respect to FIG. 3. The performance prediction system 200 may also compute a single classification label indicating an overall performance of the target entity based on the corresponding classification labels for the plurality of categories of performance, and then cause the single classification label to be displayed on the computing device, as discussed above with respect to FIG. 3.

It is contemplated that any of the other features described within the present disclosure can be incorporated into the method 400.

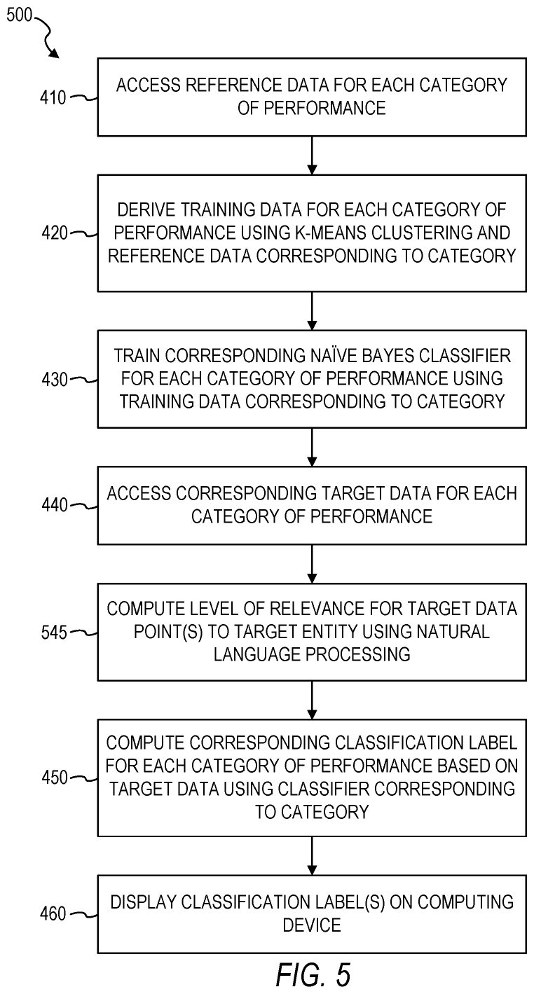

FIG. 5 is a flowchart illustrating another example method 500 of predicting performance of an entity using machine learning. The method 500 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 500 are performed by the performance prediction system 200 of FIG. 2 or any combination of one or more of its components (e.g., the content processing engine 210, the artificial intelligence component 220). The method may include operation 545 being performed subsequent to operation 440 of the method 400 and subsequent to operation 450 of the method 400.

At operation 545, the performance prediction system 200 may, for at least one category of performance in the plurality of categories of performance, compute a corresponding level of relevance for at least one target data point in the set of target data points to the target entity using a natural language processing algorithm. In some example embodiments, the computing of the corresponding classification label for the at least one category of performance in the plurality of categories of performance, at operation 450, is further based on the level of relevance computed at operation 545. The computing of the corresponding classification label for the at least one category of performance may comprise omitting the at least one target data point from use in the computing of the corresponding classification label for the at least one category of performance based on the corresponding level of relevance for the at least one target data point and a threshold relevance value. Additionally or alternatively, the computing of the corresponding classification label for the at least one category of performance may comprise weighting the at least one target data point in the computing of the corresponding classification label for the at least one category of performance based on the corresponding level of relevance for the at least one target data point.

In some example embodiments, the computing of the corresponding level of relevance for the at least one target data point in the set of target data points to the target entity using the natural language processing algorithm, at operation 545, comprises, for each target data point in the at least one target data point accessing corresponding text associated with the target data point, and then inputting the corresponding text into the natural language processing algorithm.

It is contemplated that any of the other features described within the present disclosure can be incorporated into the method 500.

In view of the disclosure above, various examples are set forth below. It should be noted that one or more features of an example, taken in isolation or combination, should be considered within the disclosure of this application.

Example 1 includes a computer-implemented method performed by a computer system having a memory and at least one hardware processor, the computer-implemented method comprising: for each category of performance in a plurality of categories of performance: accessing a corresponding set of reference data from a set of data sources corresponding to the category of performance, each corresponding set of reference data comprising a corresponding set of reference data points for each reference entity in a plurality of reference entities, each reference data point in the set of reference data points corresponding to a different data source in the set of data sources; deriving a corresponding set of training data using a k-means clustering algorithm and the set of reference data corresponding to the category of performance; training a corresponding naïve Bayes classifier using the set of training data corresponding to the category of performance; accessing a corresponding set of target data from the set of data sources corresponding to the category of performance, each corresponding set of target data comprising a set of target data points for a target entity; and computing a corresponding classification label for the category of performance based on the set of target data corresponding to the category of performance using the trained naïve Bayes classifier corresponding to the category of performance.

Example 2 includes the computer-implemented method of example 1, further comprising: for at least one category of performance in the plurality of categories of performance, computing a corresponding level of relevance for at least one target data point in the set of target data points to the target entity using a natural language processing algorithm, wherein the computing of the corresponding classification label for the at least one category of performance in the plurality of categories of performance is further based on the computed level of relevance.

Example 3 includes the computer-implemented method of example 1 or example 2, wherein the computing of the corresponding classification label for the at least one category of performance comprises omitting the at least one target data point from use in the computing of the corresponding classification label for the at least one category of performance based on the corresponding level of relevance for the at least one target data point and a threshold relevance value.

Example 4 includes the computer-implemented method of any one of examples 1 to 3, wherein the computing of the corresponding classification label for the at least one category of performance comprises weighting the at least one target data point in the computing of the corresponding classification label for the at least one category of performance based on the corresponding level of relevance for the at least one target data point.

Example 5 includes the computer-implemented method of any one of examples 1 to 4, wherein the computing of the corresponding level of relevance for the at least one target data point in the set of target data points to the target entity using the natural language processing algorithm comprises, for each target data point in the at least one target data point: accessing corresponding text associated with the target data point; and inputting the corresponding text into the natural language processing algorithm.

Example 6 includes the computer-implemented method of any one of examples 1 to 5, wherein the at least one target data point comprises at least one of: a number of backlog items in an issue tracking system, data of a burndown chart, an amount of code stored in a version control system, a level of complexity of code in the version control system, a number or amount of rewards for contributions for a specific project or task, a current career stage, a speed of promotion to a next career stage, an amount of test coverage of code, a number of trainings completed, or a number of software components.

Example 7 includes the computer-implemented method of any one of examples 1 to 6, further comprising: causing the corresponding classification labels for the plurality of categories of performance to be displayed on a computing device.

Example 8 includes the computer-implemented method of any one of examples 1 to 7, wherein the corresponding naïve Bayes classifier for each category of performance in the plurality of categories of performance computes a corresponding probability value for the classification label corresponding to the category, and the computer-implemented method further comprises: computing a single classification label indicating an overall performance of the target entity based on the corresponding probability values computed by the corresponding naïve Bayes classifiers of the plurality of categories of performance; and causing the single classification label to be displayed on a computing device.

Example 9 includes the computer-implemented method of any one of examples 1 to 8, wherein the target entity comprises a person employed by an organization, and the corresponding sets of data sources for each one of the plurality of categories of performance comprise one or more databases of the organization.

Example 10 includes a system comprising: at least one processor; and a non-transitory computer-readable medium storing executable instructions that, when executed, cause the at least one processor to perform the method of any one of examples 1 to 9.

Example 11 includes a non-transitory machine-readable storage medium, tangibly embodying a set of instructions that, when executed by at least one processor, causes the at least one processor to perform the method of any one of examples 1 to 9.

Example 12 includes a machine-readable medium carrying a set of instructions that, when executed by at least one processor, causes the at least one processor to carry out the method of any one of examples 1 to 9.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

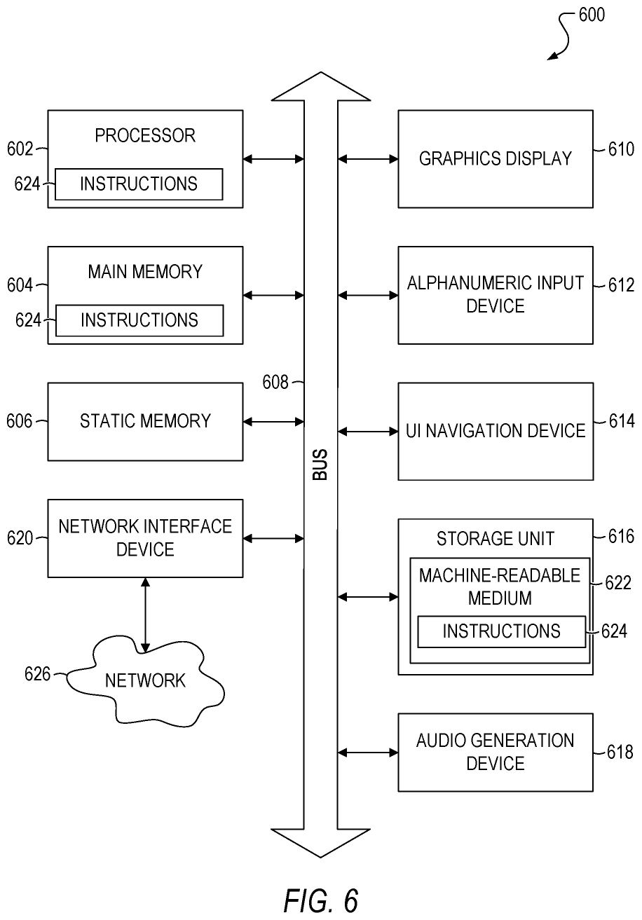

FIG. 6 is a block diagram of a machine in the example form of a computer system 600 within which instructions 624 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604, and a static memory 606, which communicate with each other via a bus 608. The computer system 600 may further include a graphics or video display unit 610 (e.g., a liquid crystal display (LCD) or a cathode ray tube (CRT)). The computer system 600 also includes an alphanumeric input device 612 (e.g., a keyboard), a user interface (UI) navigation (or cursor control) device 614 (e.g., a mouse), a storage unit (e.g., a disk drive unit) 616, an audio or signal generation device 618 (e.g., a speaker), and a network interface device 620.

The storage unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may also reside, completely or at least partially, within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMAX networks). The term “transmission medium” shall be taken to include any intangible medium capable of storing, encoding, or carrying instructions for execution by the machine, and includes digital or analog communications signals or other intangible media to facilitate communication of such software.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method performed by a computer system having a memory and at least one hardware processor, the computer-implemented method comprising:
for each category of performance in a plurality of categories of performance:
accessing a corresponding set of reference data from a set of data sources corresponding to the category of performance, each corresponding set of reference data comprising a corresponding set of reference data points for each reference entity in a plurality of reference entities, each reference data point in the set of reference data points corresponding to a different data source in the set of data sources;
deriving a corresponding set of training data using a k-means clustering algorithm and the set of reference data corresponding to the category of performance;
training a corresponding naïve Bayes classifier using the set of training data corresponding to the category of performance;
accessing a corresponding set of target data from the set of data sources corresponding to the category of performance, each corresponding set of target data comprising a set of target data points for a target entity; and
computing a corresponding classification label for the category of performance based on the set of target data corresponding to the category of performance using the trained naïve Bayes classifier corresponding to the category of performance.

2. The computer-implemented method of claim 1, further comprising:
for at least one category of performance in the plurality of categories of performance, computing a corresponding level of relevance for at least one target data point in the set of target data points to the target entity using a natural language processing algorithm,
wherein the computing of the corresponding classification label for the at least one category of performance in the plurality of categories of performance is further based on the computed level of relevance.

3. The computer-implemented method of claim 2, wherein the computing of the corresponding classification label for the at least one category of performance comprises omitting the at least one target data point from use in the computing of the corresponding classification label for the at least one category of performance based on the corresponding level of relevance for the at least one target data point and a threshold relevance value.

4. The computer-implemented method of claim 2, wherein the computing of the corresponding classification label for the at least one category of performance comprises weighting the at least one target data point in the computing of the corresponding classification label for the at least one category of performance based on the corresponding level of relevance for the at least one target data point.

5. The computer-implemented method of claim 2, wherein the computing of the corresponding level of relevance for the at least one target data point in the set of target data points to the target entity using the natural language processing algorithm comprises, for each target data point in the at least one target data point:
accessing corresponding text associated with the target data point; and
inputting the corresponding text into the natural language processing algorithm.

6. The computer-implemented method of claim 5, wherein the at least one target data point comprises at least one of: a number of backlog items in an issue tracking system, data of a burndown chart, an amount of code stored in a version control system, a level of complexity of code in the version control system, a number or amount of rewards for contributions for a specific project or task, a current career stage, a speed of promotion to a next career stage, an amount of test coverage of code, a number of trainings completed, or a number of software components.

7. The computer-implemented method of claim 1, further comprising:
causing the corresponding classification labels for the plurality of categories of performance to be displayed on a computing device.

8. The computer-implemented method of claim 1, wherein the corresponding naïve Bayes classifier for each category of performance in the plurality of categories of performance computes a corresponding probability value for the classification label corresponding to the category, and the computer-implemented method further comprises:
computing a single classification label indicating an overall performance of the target entity based on the corresponding probability values computed by the corresponding naïve Bayes classifiers of the plurality of categories of performance; and
causing the single classification label to be displayed on a computing device.

9. The computer-implemented method of claim 1, wherein the target entity comprises a person employed by an organization, and the corresponding sets of data sources for each one of the plurality of categories of performance comprise one or more databases of the organization.

10. A system of comprising:
at least one hardware processor; and
a non-transitory computer-readable medium storing executable instructions that, when executed, cause the at least one processor to perform operations comprising:
for each category of performance in a plurality of categories of performance, accessing a corresponding set of reference data from a set of data sources corresponding to the category of performance, each corresponding set of reference data comprising a corresponding set of reference data points for each reference entity in a plurality of reference entities, each reference data point in the set of reference data points corresponding to a different data source in the set of data sources;
for each category of performance in the plurality of categories of performance, deriving a corresponding set of training data using a k-means clustering algorithm and the set of reference data corresponding to the category of performance;
for each category of performance in the plurality of categories of performance, training a corresponding naïve Bayes classifier using the set of training data corresponding to the category of performance;
for each category of performance in the plurality of categories of performance, accessing a corresponding set of target data from the set of data sources corresponding to the category of performance, each corresponding set of target data comprising a set of target data points for a target entity; and
for each category of performance in the plurality of categories of performance, computing a corresponding classification label for the category of performance based on the set of target data corresponding to the category of performance using the trained naïve Bayes classifier corresponding to the category of performance.

11. The system of claim 10, wherein the operations further comprise:
for at least one category of performance in the plurality of categories of performance, computing a corresponding level of relevance for at least one target data point in the set of target data points to the target entity using a natural language processing algorithm,
wherein the computing of the corresponding classification label for the at least one category of performance in the plurality of categories of performance is further based on the computed level of relevance.

12. The system of claim 11, wherein the computing of the corresponding classification label for the at least one category of performance comprises omitting the at least one target data point from use in the computing of the corresponding classification label for the at least one category of performance based on the corresponding level of relevance for the at least one target data point and a threshold relevance value.

13. The system of claim 11, wherein the computing of the corresponding classification label for the at least one category of performance comprises weighting the at least one target data point in the computing of the corresponding classification label for the at least one category of performance based on the corresponding level of relevance for the at least one target data point.

14. The system of claim 11, wherein the computing of the corresponding level of relevance for the at least one target data point in the set of target data points to the target entity using the natural language processing algorithm comprises, for each target data point in the at least one target data point:
accessing corresponding text associated with the target data point; and
inputting the corresponding text into the natural language processing algorithm.

15. The system of claim 14, wherein the at least one target data point comprises at least one of: a number of backlog items in an issue tracking system, data of a burndown chart, an amount of code stored in a version control system, a level of complexity of code in the version control system, a number or amount of rewards for contributions for a specific project or task, a current career stage, a speed of promotion to a next career stage, an amount of test coverage of code, a number of trainings completed, or a number of software components.

16. The system of claim 10, wherein the operations further comprise:
causing the corresponding classification labels for the plurality of categories of performance to be displayed on a computing device.

17. The system of claim 10, wherein the corresponding naïve Bayes classifier for each category of performance in the plurality of categories of performance computes a corresponding probability value for the classification label corresponding to the category, and the operations further comprise:
computing a single classification label indicating an overall performance of the target entity based on the corresponding probability values computed by the corresponding naïve Bayes classifiers of the plurality of categories of performance; and
causing the single classification label to be displayed on a computing device.

18. The system of claim 10, wherein the target entity comprises a person employed by an organization, and the corresponding sets of data sources for each one of the plurality of categories of performance comprise one or more databases of the organization.

19. A non-transitory machine-readable storage medium tangibly embodying a set of instructions that, when executed by at least one hardware processor, causes the at least one processor to perform operations comprising:
for each category of performance in a plurality of categories of performance:
accessing a corresponding set of reference data from a set of data sources corresponding to the category of performance, each corresponding set of reference data comprising a corresponding set of reference data points for each reference entity in a plurality of reference entities, each reference data point in the set of reference data points corresponding to a different data source in the set of data sources;
deriving a corresponding set of training data using a k-means clustering algorithm and the set of reference data corresponding to the category of performance;
training a corresponding naïve Bayes classifier using the set of training data corresponding to the category of performance;
accessing a corresponding set of target data from the set of data sources corresponding to the category of performance, each corresponding set of target data comprising a set of target data points for a target entity; and
computing a corresponding classification label for the category of performance based on the set of target data corresponding to the category of performance using the trained naïve Bayes classifier corresponding to the category of performance.

20. The non-transitory machine-readable storage medium of claim 19, wherein the operations further comprise:
for at least one category of performance in the plurality of categories of performance, computing a corresponding level of relevance for at least one target data point in the set of target data points to the target entity using a natural language processing algorithm,
wherein the computing of the corresponding classification label for the at least one category of performance in the plurality of categories of performance is further based on the computed level of relevance.
